(19) United States
(12) Patent Application Publication
(10) Pub. No.: US 2025/0383254 A1
(43) Pub. Date: Dec. 18, 2025

(54) LEADLESS HIGH TEMPERATURE PRESSURE SENSOR

(71) Applicant: Rosemount Aerospace Inc., Burnsville, MN (US)

(72) Inventor: Weibin Zhang, Burnsville, MN (US)

(21) Appl. No.: 18/746,895

(22) Filed: Jun. 18, 2024

(51) Int. Cl. G01L 19/00; G01L 9/06; G01L 9/12; G01L 19/14

(52) U.S. Cl. CPC G01L 19/0069; G01L 19/147; G01L 9/06; G01L 9/12

(57) ABSTRACT

A leadless pressure sensor may include a substrate including a first surface in communication with an environment and a second surface opposite the first surface. The pressure sensor may include a sensing element located on the second surface for measuring a parameter associated with the environment. The pressure sensor may include a connecting assembly. The pressure sensor may include a sensing package. The sensing package may include one or more non-conductive glass frit films configured to mechanically couple the substrate to the connecting assembly to form an internal hermetic chamber. The sensing package may include one or more conductive metal films configured to electrically couple the substrate to the connecting assembly, where the one or more non-conductive glass frit films and the one or more conductive metal films are co-fired in a similar layer.

### BACKGROUND

It is often desirable for semiconductor pressure sensors to withstand high temperatures and harsh environments. For example, it may be desirable to place a semiconductor pressure sensor in an engine to detect pressure changes inside the engine.

### SUMMARY

A leadless pressure sensor is disclosed, in accordance with one or more embodiments of the present disclosure. In embodiments, the leadless pressure sensor includes a substrate, where the substrate has a first surface and a second surface, and where the first surface is in communication with an environment. In embodiments, the leadless pressure sensor includes a sensing element located on the second surface of the substrate for measuring a parameter associated with the environment. In embodiments, the leadless pressure sensor includes a connecting assembly. In embodiments, the leadless pressure sensor includes a sensing package. In embodiments, the sensing package includes one or more non-conductive glass frit films configured to mechanically couple the substrate to the connecting assembly to form an internal hermetic chamber, where the one or more non-conductive glass frit films are located on the second surface of the substrate. In embodiments, the sensing package includes one or more conductive metal films configured to electrically couple the substrate to the connecting assembly, where the one or more conductive films are located on the second surface of the substrate, and where the one or more non-conductive glass frit films and the one or more conductive metal films are co-fired in a similar layer.

In some embodiments, the one or more non-conductive glass frit films and the one or more conductive metal films may have a similar thickness within a selected tolerance.

In some embodiments, the one or more non-conductive glass frit films and the one or more conductive metal films may have a similar firing temperature within a selected tolerance.

In some embodiments, the one or more conductive metal films may be formed by printing a metal paste on the second surface of the substrate.

In some embodiments, the metal paste may include at least one of a: gold paste, silver paste, or platinum paste.

In some embodiments, the one or more non-conductive glass frit films may be formed by printing a glass frit paste on the second surface of the substrate.

In some embodiments, the connecting assembly includes a header and one or more pins.

In some embodiments, the substrate may be formed of a silicon.

In some embodiments, the leadless pressure sensor may further include a housing configured to at least partially house one or more components of the leadless pressure sensor.

In some embodiments, the one or more sensing elements may include at least one of: piezo-resistive pressure sensing elements, piezo-resistive pressure sensing elements, or capacitive pressure sensing elements.

A leadless pressure sensor is disclosed, in accordance with one or more embodiments of the present disclosure. In embodiments, the leadless pressure sensor includes a first substrate, where the first substrate has a first surface and a second surface, and where the first surface is in communication with an environment. In embodiments, the leadless pressure sensor includes a second substrate, where the second substrate includes one or more through vias, and where the second substrate includes eutectic bonds and connecting assembly bonds. In embodiments, the leadless pressure sensor includes a sensing element located on the second surface of the first substrate for measuring a parameter associated with the environment. In embodiments, the leadless pressure sensor includes a connecting assembly. In embodiments, the leadless pressure sensor includes a sensing package. In embodiments, the sensing package includes one or more non-conductive glass frit films configured to mechanically couple the first substrate to the second substrate to form an internal hermetic chamber, where the one or more non-conductive glass frit films are located on the second surface of the substrate. In embodiments, the sensing package includes one or more conductive metal films configured to electrically couple the first substrate to the one or more through vias of the second substrate, where the one or more conductive films are located on the second surface of the first substrate, and where the one or more non-conductive glass frit films and the one or more conductive metal films are co-fired in a similar layer.

In some embodiments, the one or more non-conductive glass frit films and the one or more conductive metal films may have a similar thickness within a selected tolerance.

In some embodiments, the one or more non-conductive glass frit films and the one or more conductive metal films may have a similar firing temperature within a selected tolerance.

In some embodiments, the one or more conductive metal films may be formed by printing a metal paste on the second surface of the first substrate.

In some embodiments, the metal paste may include at least one of a: gold paste, silver paste, or platinum paste.

In some embodiments, the one or more non-conductive glass frit films may be formed by printing a glass frit paste on the second surface of the first substrate.

In some embodiments, the connecting assembly includes a header and one or more pins.

In some embodiments, at least one of the first substrate and the second substrate may be formed of a silicon.

In some embodiments, the one or more eutectic bonds may be formed by transient liquid phase eutectic bonding.

In some embodiments, the leadless pressure sensor may further include a housing configured to at least partially house one or more components of the leadless pressure sensor.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are examples and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is a simplified schematic of a pressure sensor, in accordance with one or more embodiments of the disclosure.

FIG. 2 is a simplified schematic of a pressure sensor, in accordance with one or more embodiments of the disclosure.

FIG. 3A is a perspective view of a pressure sensor package device, in accordance with one or more embodiments of the disclosure.

FIG. 3B is a cross-section view of the pressure sensor package device, in accordance with one or more embodiments of the disclosure.

### DETAILED DESCRIPTION OF THE INVENTION

Reference will now be made in detail to the subject matter disclosed, which is illustrated in the accompanying drawings.

Before explaining one or more embodiments of the disclosure in detail, it is to be understood the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one,” “one or more,” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of or sub-combination of two or more such features, along with any other features which may not necessarily be expressly described or inherently present in the instant disclosure.

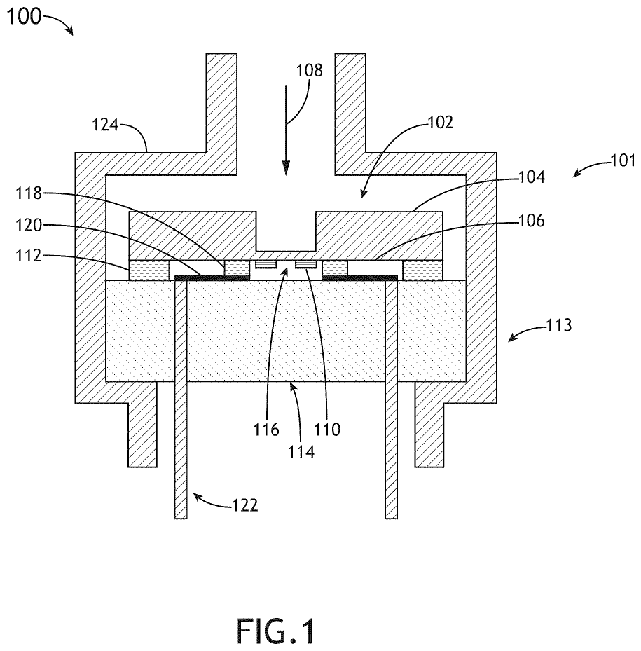

FIGS. 1-3B in general illustrate a leadless high temperature pressure sensor device, in accordance with one or more embodiments of the disclosure.

It is often desirable for semiconductor pressure sensors to be able to withstand high temperatures and harsh environments. For example, it may be desirable to place a pressure sensor in an engine to detect pressure changes inside the engine. Existing pressure sensors are often wire-bonded pressure sensors, where the pressure sensor includes wire leads for electrical signal transmission. However, the wire bonds of said wire-bonded pressure sensors often fail at high temperatures due to the inter-metallic diffusion between the wire bonds and the bonding surfaces. For example, sensors with gold wire bonds are typically used for applications with temperatures below 300° C. Further, the wire bonds of said wire-bonded pressure sensors are subjective to mechanical vibration and thermal cycling, thus increasing the risk of mechanical fatigue failures.

Some existing pressure sensors are leadless (e.g., do not include wire-bonding). For example, such pressure sensors may include film transient liquid phase eutectic wafer/die bonding, where the metallic eutectic layer can serve as both the electrical transmission path and the mechanical bonding layer to provide the required hermeticity for the pressure sensor. The transient liquid phase eutectic layer is typically very thin (e.g., sub-micron thickness). However, this thin nature of the liquid phase eutectic layer requires the bonding surface to be sub-micron flat, which makes the bonding process and bonding surface preparation very challenging. Thus, it is difficult to achieve a good electrical connection and the required hermeticity needed to measure the signal when there is any amount of surface roughness (or unevenness).

Some other existing leadless pressure sensors are achieved using conductive frit as the electrical transmission path. For such pressure sensors, the conductive frit may contact the sensor electric pads or lead directly. However, such direct contact may cause failure at high temperature due to the chemical reactions between frit and the sensor contact pads.

As such, there is a need for a leadless high temperature pressure sensor device, which cures one or more shortfalls of the previous approaches. The pressure sensor device should withstand high temperature applications (e.g., between approximately 400° C. and 700° C.). For example, the pressure sensor device may include a co-fired non-conductive glass frit film and conductive metallic paste film in the same layer, where the glass frit provides bonding strength and hermeticity and the metal paste provides electronic connectivity. In this regard, there is no environmental exposure to the electric connection (e.g., conductive metallic paste film) or sensing element (or die) itself. As such, the pressure sensor device may provide a robust bonding process, tolerant to surface roughness (or unevenness), due to the squeezable natures of both the glass frit and the metallic paste film.

It is noted herein that the leadless high temperature pressure sensor device may be implemented in any environment or number of environments. For example, the environment may include any type of vehicle known in the art. For instance, the vehicle may be any air, land, or water-based personal equipment or vehicle; any air, land, or water-based commercial equipment or vehicle; any air, land, or water-based military equipment or vehicle known in the art. By way of another example, the environment may include a commercial or industrial establishment (e.g., a home or a business).

Where the environment may be an aviation environment, the aircraft cabin designs need to be certified in accordance with aviation guidelines and standards, while being designed so as not to lose the intended functionality of the structures and/or monuments in the aircraft cabin. For example, the leadless high temperature pressure sensor device may need to be configured in accordance with aviation guidelines and/or standards put forth by, but not limited to, the Federal Aviation Administration (FAA), the European Aviation Safety Agency (EASA) or any other flight certification agency or organization or any other guidelines agency or organization, or the like.

FIG. 1 illustrates a simplified schematic of a leadless high temperature pressure sensor 100, in accordance with one or more embodiments of the disclosure.

The pressure sensor 100 may include a substrate 102. For example, the substrate 102 may include a first surface 104 (e.g., top surface) and a second surface 106 (e.g., bottom surface), where the first surface 104 is in communication with an environment 108.

The substrate 102 may include a wafer. For example, the wafer may include a micro-electromechanical system (MEMs) chip formed of silicon, sapphire, or other substrate materials.

The pressure sensor 100 may include one or more sensing elements 110 configured to measuring a parameter associated with the environment 108. For example, the one or more sensing elements 110 may be located on the second surface 106 of the substrate 102. The sensing elements 110 may be piezo-resistive, piezo-electric, or capacitive. The one or more sensing elements 110 may include one or more sensing dies.

The pressure sensor 100 may include one or more non-conductive glass frit films 112 located on the second surface 106 of the substrate 102. For example, the one or more non-conductive glass frit films 112 may be configured to mechanically couple the substrate 102 to a connecting assembly 113 (e.g., header 114) to form an internal hermetically sealed chamber 116. In this regard, the one or more sensing elements 110 may be contained within the one or more conductive metal films 118 and not exposed to the environment 108. As previously noted herein, the sensing elements of conventional pressure sensors are often exposed to the environment, causing contamination. Thus, it is desirable to have a pressure sensor 100 where the sensing environment is isolated to prevent said contamination.

The one or more non-conductive glass frit films 112 may be formed by printing a glass frit paste on the second surface 106 of the substrate 102. For example, the glass frit paste may be screen printed on the second surface 106 of the substrate 102. Once printed, the glass frit paste may be bonded and fired to form the one or more non-conductive glass frit films 112. In this regard, the one or more non-conductive glass frit films 112 may provide bonding strength and hermeticity needed for pressure sensing. It is contemplated herein that the glass frit may have wide range of firing temperature ranges, such as between 300° C. to 900° C., depending on the glass frit compositions.

The pressure sensor 100 may include one or more conductive metal films 118 located on the second surface 106 of the substrate 102. For example, the internal hermetically sealed chamber 116 may be configured to electrically couple the substrate 102 to the header 114. For instance, the pressure sensor 100 may include one or more contact films 120 electrically coupled to one or more pins 122 of the header 114. In this regard, the one or more conductive metal films 118 may provide an electrical connection between the substrate 102 and one or more pins 122 via the connection point between the one or more conductive metal films 118 and one or more contact films 120.

The one or more conductive metal films 118 may be formed by printing a metal paste on the second surface 106 of the substrate 102. For example, the metal paste may be screen printed on the second surface 106 of the substrate 102. Once printed, the metal paste may be bonded and fired to form the one or more internal hermetically sealed chamber 116. In this regard, the two target surfaces are aligned and bonded, such that the two surfaces are electrically connected by the one or more conductive metal films 118. It is contemplated herein that the metal paste of the internal hermetically sealed chamber 116 may be formed of any type of metallic paste such as, but not limited to, a gold paste (e.g., having a 850 C firing temperature), silver paste (e.g., having a 550 C firing temperature), platinum paste, or the like.

The one or more non-conductive glass frit films 112 and the one or more conductive metal films 118 may be co-fired in a similar layer. For example, the one or more non-conductive glass frit films 112 and the one or more conductive metal films 118 have a similar firing temperature within a selected tolerance. It is contemplated that the firing temperature is chosen such that the glass frit of the one or more non-conductive glass frit films 112 is fully cured. As such, the metal paste of the one or more conductive metal films 118 may be fully cured or partially cured (e.g., at least approximately 80% cured).

The one or more non-conductive glass frit films 112 and the one or more conductive metal films 118 may have a similar thickness within a selected tolerance. It is contemplated herein that due to the fact that both the one or more non-conductive glass frit films 112 and the one or more conductive metal films 118 are compressible, both films 112, 118 are co-fired with the same thickness during the bonding process with compression stress at the selected curing temperature. In a non-limiting example, the final thickness of the one or more non-conductive glass frit films 112 and the one or more conductive metal films 118 may be between approximately 5 μm and 15 μm.

It is contemplated herein that it may be advantageous to select the parameters of the metal paste of the one or more conductive metal films 118 prior to selecting the parameters of the glass frit of the one or more non-conductive glass frit films 112. In this regard, once the parameters of the metal paste of the one or more conductive metal films 118 are selected, the parameters of the glass frit of the one or more non-conductive glass frit films 112 may be selected in accordance with the above constraints.

The one or more non-conductive glass frit films 112 and the one or more conductive metal films 118 may be spaced a select distance apart. For example, the one or more non-conductive glass frit films 112 and the one or more conductive metal films 118 may be separated a select distance, such that they do not make contact with one another. For instance, as shown in FIG. 1, the one or more non-conductive glass frit films 112 may be spaced at least a length of the one or more contact films 120 from the one or more conductive metal films 118. In this regard, the possibility of reaction between the glass frit and the electric contacts at high temperatures is eliminated.

It is contemplated herein that some existing pressure sensors utilize a conductive glass frit (e.g., glass frit including metallic conductive particles) to provide both bonding and electric connection. The problem with said technique is that the glass metal frit may react with device contact metal at high temperatures, causing electric failure.

The pressure sensor 100 may include a housing 124 configured to at least partially house one or more components of the pressure sensor 100. For example, the housing 124 may be configured to at least partially house the substrate 102, one or more sensing elements 110, one or more non-conductive glass frit films 112, header 114, one or more conductive metal films 118, one or more contact films 120, and one or more pins 122.

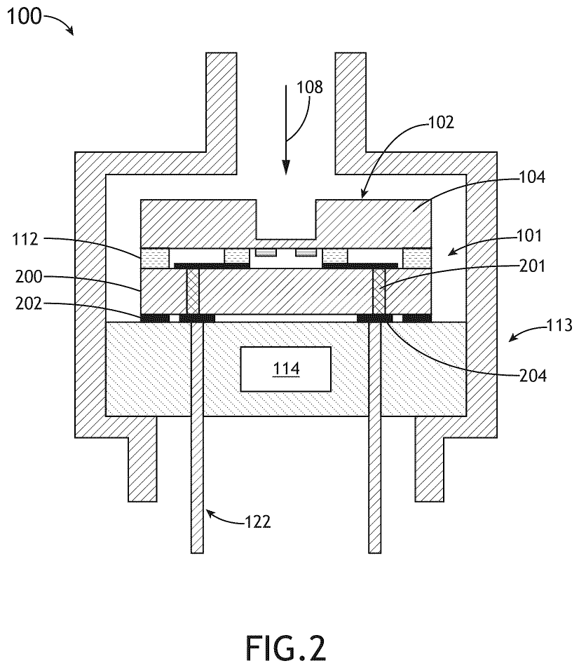

Referring to FIG. 2, the pressure sensor 100 may further include a via wafer 200 including one or more conductive through vias 201. The via wafer 200 may be bonded to the substrate wafer using the co-firing process mentioned above at wafer level. For example, the glass frit of the one or more non-conductive glass frit films 112 and the metal paste of the one or more conductive metal films 118 may be co-fired between the substrate 102 and the via wafer 200 to provide both electric connection and hermeticity (as previously discussed herein with respect to FIG. 1). The bonded wafer may be singulated into individual sensing dies.

The singulated bonded wafer 100/200 may be attached to the header 114 using different methods. Since the singulated die is hermetic already, the hermeticity on this die-header attachment is only desirable but not required. In a non-limiting example, the liquid phase eutectic bonding 202 includes a gold-based transient liquid phase eutectic bonding process, as generally discussed in U.S. Patent Publication No. 2007/0013014, published on Jan. 18, 2007, which is herein incorporated by reference.

The via wafer 200 may further include connecting assembly bond members 204. For example, the connecting assembly bond members 204 may include metal paste bond members 204 for electrically coupling to the one or more pins 122 of the header 114.

It is contemplated herein that by adding a via wafer 200 to the pressure sensor pressure sensor 100, the typical high temperature co-firing process is done at the wafer level. In this regard, the bonded die can be attached to the header 114 at a lower temperature than the high temperature of the co-firing process.

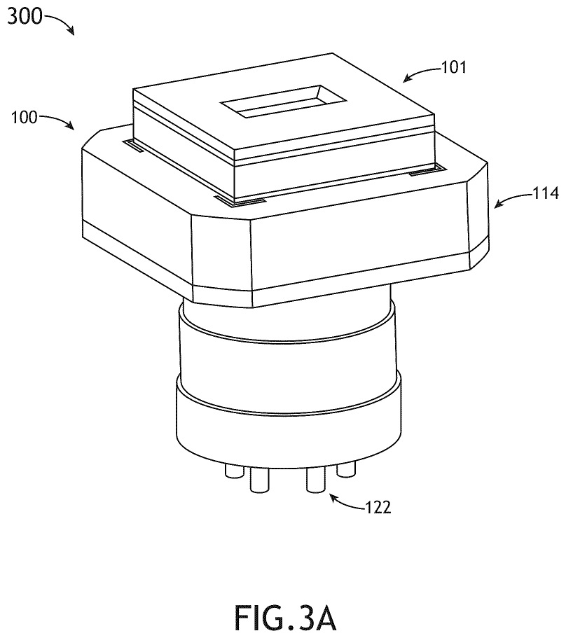

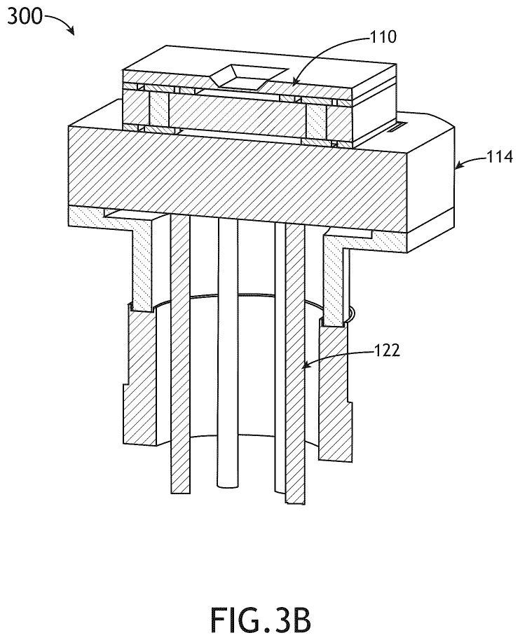

Besides the traditional ceramic-pin header configuration, referring to FIGS. 3A-3B, in a non-limiting example, the pressure sensor 100 may be used in a high temperature co-fired ceramic (HTCC) package device assembly 300. In this regard, the assembly 300 may be used within a high temperature environment to measure pressure.

In a non-limiting example, as shown in FIG. 3A-3B, the device package 101 may be attached to the HTCC header 114. The electric connection inside the header 114 is through the imbedded metallic vias and traces, which are co-fired with the ceramic. The additional pins 122 can be brazed for further electric connection. In such design, the pin 122 locations are more flexible.

Although the disclosure has been described with reference to the embodiments illustrated in the attached drawing figures, equivalents may be employed and substitutions made herein without departing from the scope of the claims. Components illustrated and described herein are merely examples of a system/device and components that may be used to implement embodiments of the disclosure and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A leadless pressure sensor comprising:
a substrate, wherein the substrate has a first surface and a second surface, wherein the first surface is in communication with an environment;
a sensing element located on the second surface of the substrate for measuring a parameter associated with the environment;
a connecting assembly; and
a sensing package, wherein the sensing package comprises:
one or more non-conductive glass frit films configured to mechanically couple the substrate to the connecting assembly to form an internal hermetic chamber, wherein the one or more non-conductive glass frit films are located on the second surface of the substrate; and
one or more conductive metal films configured to electrically couple the substrate to the connecting assembly, wherein the one or more conductive metal films are located on the second surface of the substrate,
wherein the one or more non-conductive glass frit films and the one or more conductive metal films are co-fired in a similar layer.

2. The leadless pressure sensor of claim 1, wherein the one or more non-conductive glass frit films and the one or more conductive metal films have a similar thickness within a selected tolerance.

3. The leadless pressure sensor of claim 1, wherein the one or more non-conductive glass frit films and the one or more conductive metal films have a similar firing temperature within a selected tolerance.

4. The leadless pressure sensor of claim 1, wherein the one or more conductive metal films are formed by printing a metal paste on the second surface of the substrate.

5. The leadless pressure sensor of claim 4, wherein the metal paste includes at least one of a:
gold paste, silver paste, or platinum paste.

6. The leadless pressure sensor of claim 1, wherein the one or more non-conductive glass frit films are formed by printing a glass frit paste on the second surface of the substrate.

7. The leadless pressure sensor of claim 1, wherein the connecting assembly comprises:
a header; and
one or more pins.

8. The leadless pressure sensor of claim 1, wherein the substrate is formed of a silicon.

9. The leadless pressure sensor of claim 1, further comprising:
a housing configured to at least partially house one or more components of the leadless pressure sensor.

10. The leadless pressure sensor of claim 1, wherein the sensing element includes at least one of:
piezo-resistive pressure sensing elements, piezo-resistive pressure sensing elements, or capacitive pressure sensing elements.

11. A leadless pressure sensor comprising:
a first substrate, wherein the first substrate has a first surface and a second surface, wherein the first surface is in communication with an environment;
a second substrate, wherein the second substrate includes one or more through vias, wherein the second substrate includes one or more eutectic bonds and one or more connecting assembly bonds;
a sensing element located on the second surface of the first substrate for measuring a parameter associated with the environment;
a connecting assembly; and
a sensing package, wherein the sensing package comprises:
one or more non-conductive glass frit films configured to mechanically couple the first substrate to the second substrate to form an internal hermetic chamber, wherein the one or more non-conductive glass frit films are located on the second surface of the first substrate; and
one or more conductive metal films configured to electrically couple the first substrate to the one or more through vias of the second substrate, wherein the one or more conductive metal films are located on the second surface of the first substrate,
wherein the one or more non-conductive glass frit films and the one or more conductive metal films are co-fired in a similar layer.

12. The leadless pressure sensor of claim 11, wherein the one or more non-conductive glass frit films and the one or more conductive metal films have a similar thickness within a selected tolerance.

13. The leadless pressure sensor of claim 11, wherein the one or more non-conductive glass frit films and the one or more conductive metal films have a similar firing temperature within a selected tolerance.

14. The leadless pressure sensor of claim 11, wherein the one or more conductive metal films are formed by printing a metal paste on the second surface of the first substrate.

15. The leadless pressure sensor of claim 14, wherein the metal paste includes at least one of a:
gold paste, silver paste, or platinum paste.

16. The leadless pressure sensor of claim 11, wherein the one or more non-conductive glass frit films are formed by printing a glass frit paste on the second surface of the first substrate.

17. The leadless pressure sensor of claim 11, wherein the connecting assembly comprises:
a header; and
one or more pins.

18. The leadless pressure sensor of claim 11, wherein at least the first substrate or the second substrate is formed of a silicon.

19. The leadless pressure sensor of claim 11, wherein the one or more eutectic bonds are formed by transient liquid phase eutectic bonding.

20. The leadless pressure sensor of claim 11, further comprising:
a housing configured to at least partially house one or more components of the leadless pressure sensor.
